(19) United States
(12) Patent Application Publication
(10) Pub. No.: US 2023/0323089 A1
(43) Pub. Date: Oct. 12, 2023

(54) CURABLE COMPOSITION

(71) Applicant: KANEKA NORTH AMERICA LLC, Pasadena, TX (US)

(72) Inventors: Atsushi FUKUNAGA, Pasadena, TX (US); Chin-Chang SHEN, Pasadena, TX (US); Kenneth SUTHERLAND, JR., Pasadena, TX (US); Yu ITANO, Takasago-shi (JP); Akira OGAWA, Takasago-shi (JP)

(73) Assignee: KANEKA NORTH AMERICA LLC, Pasadena, TX (US)

(21) Appl. No.: 18/334,706

(22) Filed: Jun. 14, 2023

Related U.S. Application Data
(63) Continuation of application No. 17/066,580, filed on Oct. 9, 2020, now abandoned.
Application No. 17/066,580 is a continuation of application No. 16/142,117, filed on Sep. 26, 2018, now abandoned.
Application No. 16/142,117 is a continuation of application No. 15/401,571, filed on Jan. 9, 2017, now abandoned.
Application No. 15/401,571 is a continuation of application No. 14/834,240, filed on Aug. 24, 2015, now abandoned.
(60) Provisional application No. 62/040,764, filed on Aug. 22, 2014.

(51) Int. Cl. C08K 7/14; C08K 3/40

(52) U.S. Cl. CPC C08K 7/14; C08K 3/40; C08K 2201/003; C08K 2201/016

(57) ABSTRACT

Provided is a curable composition having superior weather resistance which is obtained from a cured product containing a polyoxyalkylene polymer comprising a reactive silicon group. The curable composition contains (A) a reactive-silicon-group-containing polyoxyalkylene polymer having a number-average molecular weight of 2,000 to 50,000 and containing 1.1 to 5 reactive silicon groups within a single molecule, and (B) from 0.01 to 100 parts by weight of a powdered-glass-based filler based on 100 parts of the component (A).

### CROSS-REFERENCE TO RELATED APPLICATIONS

This is a continuation of U.S. application Ser. No. 15/401,571, filed Jan. 9, 2017, which is a continuation of U.S. application Ser. No. 14/834,240, filed Aug. 24, 2015, which is based upon and claims the benefit of priority to U.S. Provisional Application No. 62/040,764, filed Aug. 22, 2014, all of which are incorporated herein by reference, in their entireties.

### FIELD OF THE INVENTION

The present invention relates to a curable composition containing an organic polymer comprising a silicon-containing functional group that is capable of cross-linking by forming siloxane bonds (hereafter also referred to as a “reactive silicon group”). More specifically, the present invention relates to a highly weather-resistant curable composition containing an organic (polyoxyalkylene-based) polymer comprising a reactive silicon group.

### PRIOR ART

Organic polymers containing at least one reactive silicon atom within their molecule are disclosed in Unexamined Japanese Patent Application Publication S61-141761, Unexamined Japanese Patent Application Publication S61-218632, Unexamined Japanese Patent Application Publication S61-233043, Unexamined Japanese Patent Application Publication H01-171683, Unexamined Japanese Patent Application Publication H01-279958, Unexamined Japanese Patent Application Publication H05-065407, Unexamined Japanese Patent Application Publication H05-065454, Unexamined Japanese Patent Application Publication H10-060253, and the like; these polymers are possess the property of forming cross-links, yielding a rubber-like cured product, as the result of siloxane bond formation occurring along with silyl group hydrolysis reactions and the like induced by factors such as humidity at room temperature. Curable compositions that react with humidity in the air and cure into a rubber-like state exhibit superior storage stability, weather resistance, flame resistance, contamination resistance, and the like, and are widely used as sealing materials, adhesives, coating materials, and the like.

Among organic polymers comprising reactive silicon groups, polymers having polyoxyalkylene main chain frames exhibit comparatively low viscosity and are easy to handle, and exhibit good weather resistance, making them suited for use as sealing materials or coatings; however, the increased lifespan of structures in recent years as well as the increased demands placed upon residences in terms of appearance has led to a demand for improved weather resistance. Unexamined Japanese Patent Application Publication S61-233043 and Unexamined Japanese Patent Application Publication 2001-164236 disclose adding an additive UV absorber or light stabilizer In order to improve weather resistance; however, additive UV absorbers and light stabilizers bleed out onto the surface, making it difficult to maintain weather resistance over extended periods. Unexamined Japanese Patent Application Publication S59-122541 discloses the feature of blending an acrylic copolymer into a polyoxyalkylene polymer comprising a reactive silicon group in order to improve weather resistance, and indicates that doing so allows for dramatic improvement in weather resistance; however, degradation occurs following extended exposure, with the result that there is a demand for further improvement in weather resistance. Moreover, methods in which these additives are used or methods in which an acrylic copolymer is blended with a polyoxyalkylene polymer present the problem of increased costs compared to cases in which a curable composition containing a polyoxyalkylene polymer alone is used, and methods in which an acrylic copolymer is blended with a polyoxyalkylene polymer present the problem that viscosity increases, reducing workability.

### SUMMARY OF THE INVENTION

### Problem to be Solved by the Invention

In view of the circumstances described above, an object of the present invention is to provide a curable composition that exhibits superior weather resistance while maintaining good workability, the composition being obtained using a cured product containing a polyoxyalkylene polymer comprising a reactive silicon group.

### Means for Solving the Problem

As the result of dedicated research toward solving the problem described above, the inventors discovered that a cured product exhibiting workability comparable to that of existing compositions and good weather resistance can be obtained by adding a specific powdered-glass-based filler to a curable composition, thereby arriving at the present invention.

Specifically, the present invention relates to:
(1) a curable composition containing (A) a reactive-silicon-group-containing polyoxyalkylene polymer having a number-average molecular weight of 2,000 to 50,000 and containing 1.1 to 5 reactive silicon groups within a single molecule, and (B) from 0.01 to 100 parts by weight of a powdered-glass-based filler; and

(2) the curable composition according to (1), wherein the powdered-glass-based filler constituting component (B) consists of particles having sharp raised and recessed sections on the surfaces thereof, or having needle-like or fiber-like shapes.

### Effects of the Invention

By using the curable composition containing a reactive-silicon-group-containing polyoxyalkylene polymer according to the present invention, and adding a specific powdered-glass-based filler thereto, it is possible to produce a cured product of the curable composition exhibiting workability comparable to that of existing compositions and good weather resistance.

### BEST MODE FOR EMBODYING THE INVENTION

The present invention will now be described in detail.

The present invention relates to a curable composition containing (A) a reactive-silicon-group-containing polyoxyalkylene polymer having a number-average molecular weight of 200050,000 and containing 1.1 to 5 reactive silicon groups within a single molecule, and (B) from 0.01 to 100 parts by weight of a powdered-glass-based filler.

The reactive silicon group contained in the reactive-silicon-group-containing polyoxyalkylene polymer contains a hydroxyl group or a hydrolyzable group bonded to a silicon atom, and is capable of cross-linking by forming siloxane bonds via a reaction accelerated by a silanol condensation catalyst. One example of a reactive silicon group is represented by the following general formula (1):

—SiR¹₃₋ₐX_{z} (1)

(wherein R¹ is an alkyl group comprising 1 to 20 carbon atoms, an aryl group comprising 6 to 20 carbon atoms, an aralkyl group comprising 7 to 20 carbon atoms, or a triorganosiloxy group represented by (R′)₃SiO— (wherein each R′ individually represents a substituted or unsubstituted hydrocarbon group comprising 1 to 20 carbon atoms); each X individually represents a hydroxyl group or a hydrolyzable group; and a is one of 1, 2, or 3).

There is no particular limitation upon the hydrolyzable group; any conventionally known hydrolyzable group is acceptable. Specific examples include hydrogen atoms, halogen atoms, alkoxy groups, acyloxy groups, ketoximate groups, amino groups, amide groups, acid amide groups, aminooxy groups, mercapto groups, and alkenyloxy groups. Of these, hydrogen atoms, alkoxy groups, acyloxy groups, ketoximate groups, amino groups, amide groups, aminooxy groups, mercapto groups, and alkenyloxy groups are preferable, with alkoxy groups being especially preferable due to their gentle hydrolyzability and ease of handling.

From one to three hydrolyzable groups or hydroxyl groups can be bonded to a single silicon atom, with two or three groups being preferable for the sake of hardness. If two or more hydrolyzable groups or hydroxyl groups are bonded to the silicon atom, the groups may be identical or different groups. A reactive silicone group containing three hydroxyl groups or hydrolyzable groups on one silicon atom is preferable, as such a group is highly active and yields good hardness, and yields superior restorability, durability, and creep resistance in the cured product. On the other hand, a reactive silicone group containing two hydroxyl groups or hydrolyzable groups on one silicon atom is preferable for the sake of superior storage stability and high elongation and strength in the cured product.

Specific examples of R1 in general formula (1) include alkyl groups such as methyl groups and ethyl groups, cycloalkyl groups such as cyclohexyl groups, aryl groups such as phenyl groups, aralkyl groups such as benzyl groups, and triorganosiloxy groups represented by (R′)₃SiO—, wherein R′ is a methyl group, phenyl group, or the like. Of these, a methyl group is especially preferable.

More specific examples of reactive silicon groups include trimethoxysilyl groups, triethoxysilyl groups, triisopropxysilyl groups, dimethoxymethylsilyl groups, diethoxymethylsilyl groups, and diisopropoxymethylsilyl groups. Trimethoxysilyl groups, triethoxysilyl groups, and dimethoxymethylsilyl groups are more preferable in order to obtain high activity and good hardness, with a trimethoxysilyl group being especially preferable.

A dimethoxymethylsilyl group is especially preferable for the sake of storage stability. A triethoxysilyl group or diethoxymethylsilyl group is especially preferable for the fact that the alcohol produced by the hydrolysis reaction of the reactive silicon group is ethanol, resulting in a higher level of safety.

The reactive silicon group may be introduced using a known method. Examples of specific methods include those described hereafter.

(i) A polyoxyalkylene comprising a functional group such as a hydroxyl group in its molecule is reacted with an organic compound comprising an active group that exhibits reactivity with the functional group and an unsaturated group to obtain a polyoxyalkylene polymer containing an unsaturated group. Alternatively, the polymerization is performed with an unsaturated-group-containing epoxy compound to obtain an unsaturated-group-containing polyoxyalkylene polymer. Next, a hydrosilane comprising a reactive silicon group is used to hydrosilylate the obtained reaction product.

(ii) A polyoxyalkylene polymer containing an unsaturated group obtained in a manner similar to that of method (i) is reacted with a compound containing a mercapto group and a reactive silicon group.

(iii) A polyoxyalkylene polymer comprising a functional group such as a hydroxyl group, epoxy group, or isocyanate group in its molecule is reacted with a compound comprising a functional group that exhibits reactivity with the first functional group and a reactive silicon group.

Of the methods described above, method (i) or a version of method (iii) in which a polymer capped with hydroxyl groups and a compound comprising an isocyanate group and a reactive silicon group are reacted are preferable, as they allow for a high rate of conversion within a comparatively short reaction time. In addition, method (i) is especially preferable because the polyoxyalkylene polymer containing a reactive silicon group obtained according to method (i) yields a curable polymer that is lower in viscosity and more workable than the polyoxyalkylene polymer obtained according to method (ii), and the polyoxyalkylene polymer obtained according to method (iii) has a strong mercaptosilane-derived odor.

Non-limiting specific examples of the hydrosilane compound used in method (i) include: halogenated silanes such as trichlorosilane, methyl dichlorosilane, dimethyl chlorosilane, and phenyls dichlorosilane; alkoxysilanes such as trimethoxysilane, triethoxysilane, methyl diethoxysilane, methyl dimethoxysilane, phenyl dimethoxysilane, and 1-[2-(trimethoxysilyl)ethyl)-1,1,3,3-tetramethyl disiloxane; acyloxysilane groups such as methyl diacetoxysilane and phenyl diacetoxysilane; and ketoxymate silanes such as bis(dimethylketoxymate)methylsilane and bis(cyclohexylketoxymate)methylsilane. Of these, a halogenated silane or alkoxysilane is preferable, with an alkoxysilane being especially preferable due to the gentle hydrolyzability and ease of handling of the obtained curable composition. Among the various alkoxysilanes, methyl dimethoxysilane is especially preferable as it is easy to obtain and yields a polyoxyalkylene-polymer-containing curable composition of high hardness, storage stability, elongation properties, and tensile strength. Trimethoxysilane is especially preferable for the sake of the hardness and shape restorability of the obtained curable composition.

A non-limiting example of synthesis method (ii) is to introduce a compound comprising a mercapto group and a reactive silicon group at an unsaturated bond site on a polyoxyalkylene polymer via a radical adduction reaction in the presence of a radical initiator and/or a radical source. Non-limiting specific examples of the compound comprising a mercapto group and a reactive silicon group include gamma-mercaptopropyltrimethoxysilane, gamma-mercaptopropylmethyldimethoxysilane, gamma-mercaptopropyltriethoxysilane, gamma-mercaptopropylmethyldiethoxysilane, mercaptomethyltrimethoxysilane, and mercaptomethyltriethoxysilane.

Of the various possible versions of synthesis method (iii), Unexamined Japanese Patent Application Publication H03-047825, for example, discloses a method involving reacting a polymer capped with hydroxyl groups and a compound containing a reactive silicon group; however, the present invention is particularly not limited to such a method. Non-limiting specific examples of the compound comprising an isocyanate group and a reactive silicon group include gamma-isocyanate propyl trimethoxysilane, gamma-isocyanate propyl methyl dimethoxysilane, gamma-isocyanate propyl triethoxysilane, gamma-isocyanate propyl methyl diethoxysilane, isocyanate methyl trimethoxysilane,isocyanate methyl triethoxysilane, isocyanate methyl dimethoxymethylsilane, and isocyanate methyl diethoxymethylsilane.

A silane compound in which 300 lies in groups are bonded to one silicon atom, such as trimethoxysilane, may engage in a disproportionation reaction. As the disproportionation reaction progresses, considerably dangerous compounds such as dimethoxysilane and tetrahydrosilane are produced. However, a disproportionation reaction of this sort will not occur if gamma-mercaptopropyl trimethoxysilane or gamma-isocyanate propyl trimethoxysilane is used. Therefore, if a group in which three hydrolyzable groups, such as trimethoxysilyl groups, are bonded to a single silicon atom is used as the silicon-containing-group, it is preferable to use synthesis method (ii) or (iii).

Meanwhile, a disproportionation reaction will not occur in the case of the silane compound disclosed in general formula (2):

H—(SiR²₂O)ₘSiR²₂—R³—SiX₃ (2)

(wherein X is described above; 2m+2 R² is each individually a hydrocarbon carbon group or a triorganosiloxy group represented by (R″)₃ (wherein each R″ is individually a substituted or unsubstituted hydrocarbon group comprising 1 to 20 carbon atoms), with a hydrocarbon group comprising 1 to 20 carbon atoms being preferable, a hydrocarbon group comprising 1 to 8 carbon atoms being more preferable, and a hydrocarbon group comprising 1 to 4 carbon atoms being especially preferable in terms of ease of procurement and cost; R³ is a divalent organic group, with a divalent hydrocarbon group comprising 1 to 12 carbon atoms being preferable, a divalent hydrocarbon group comprising 2 to 8 carbon atoms being more preferable, and a divalent hydrocarbon group comprising 2 carbon atoms being especially preferable in terms of ease of procurement and cost; and m is an integer from 0 to 19, with 1 being preferable in terms of ease of procurement and cost). Therefore, if a group in which three hydrolyzed groups are bonded to a single silicon atom is introduced in synthesis method (i), it is preferable to use a silane compound represented by general formula (2).

Specific examples of the silane compound represented by general formula (2) include

1[2-(trimethoxysilyl)ethyl]-1,1,3,3-tetramethyl disiloxane,
1[2-(trimethoxysilyl)propyl]-1,1,3,3-tetramethyl disiloxane, and
1[2-(trimethoxysilyl)hexyl]-1,1,3,3-tetramethyl disiloxane.

The polyoxyalkylene polymer comprising a reactive silicon group may be linear or branched, and has a number-average molecular weight in terms of polystyrene as determined via GPC of roughly 500 to 100,000, more preferably 1,000 to 50,000, especially preferably 3,000 to 30,000. A number-average molecular weight of less than 500 tends to be disadvantageous in terms of the elongation properties of the cured product, and a molecular weight exceeding 100,000 tends to be disadvantageous in terms of workability as the composition becomes highly viscous.

In order to obtain a rubber-like cured product exhibiting high strength, high elongation, and a low modulus of elasticity, the molecule of the polyoxyalkylene polymer should contain an average of at least one, preferably 1.1 to 5, of the reactive silicon group contained in the polymer. If the average number of reactive silicon groups in the molecule is less than one, hardness will be insufficient, making it difficult to manifest satisfactory rubber elasticity behavior. The reactive silicon group may be present on the terminals of the main chain, a side chain, or both of the molecular chain of the polyoxyalkylene polymer. In particular, having a reactive silicon group present on the terminals of the main chain of the molecular chain makes it easy to obtain a rubber-like cured product exhibiting high strength, high elongation, and a low modulus of elasticity, as this will increase the length of the effective mesh chain of the polyoxyalkylene polymer contained in the final cured product.

The polyoxyalkylene polymer is a polymer comprising a repeating unit substantially represented by general formula (3):

—R⁴—O— (3)

(wherein R⁴ is a straight or branched alkylene group comprising 1 to 14 carbon atoms), with R⁴ in formula (3) preferably being a straight or branched alkylene group comprising 1 to 4 carbon atoms, more preferably 2 to 4 carbon atoms.

Specific examples of the repeating unit represented by general formula (3) include:

—CH₂O—, —CH₂CH₂O—, —CH₂CH(CH₃)O—, —CH₂CH(C₂H₅)O—, —CH₂C(CH₃)₂O—, and —CH₂CH₂CH₂CH₂O—.

The backbone of the main chain of the polyoxyalkylene polymer may be constituted by only one type of repeating unit, or by two or more types of repeating units. In particular, if the composition is used as a sealant, coating, or the like, a polymer primarily composed of a propylene oxide polymer is preferable due to its amorphous structure and comparatively low viscosity.

Non-limiting examples of the method used to synthesize the polyoxyalkylene polymer include: polymerizing using an alkaline catalyst such as KOH; the polymerization method using a transition metal compound/porphyrin complex catalyst such as a catalyst obtained by reacting an organic aluminum compound and porphyrin disclosed in Unexamined Japanese Patent Application Publication S61-215623; the polymerization methods using a complex metal/cyanide complex catalyst disclosed in Examined Japanese Patent Applications S46-027250 and S59-015336 and U.S. Pat. No. 3,278,457, 3,278,458, 3,278,459, 3,427,256, 3,427,334, and 3,427,335; the polymerization method using a catalyst constituted by a polyphosphazene salt disclosed in Unexamined Japanese Patent Application Publication H10-273512; and the polymerization method using a catalyst constituted by a phosphazene compound disclosed in Unexamined Japanese Patent Application Publication H11-060722.

Non-limiting examples of the method used to produce the polyoxyalkylene polymer comprising a reactive silicon group include those disclosed in Examined Japanese Patent Applications S45-036319 and S46-012154, Unexamined Japanese Patent Application Publications S50-156599, S54-006096, S55-013767, S55-013468, and S57-164123, Examined Japanese Patent Application H03-002450, and U.S. Pat. Nos. 3,632,557, 4,345,053, 4,366,307, and 4,960,844; and or the high-molecular-weight, narrow-molecular-weight-distribution polyoxyalkylene polymers having number-average molecular weights of at least 6,000 and an Mw/Mn ratio of 1.6 or less proposed in Unexamined Japanese Patent Application Publications S61-197631, S61-215622, S61-215623, S61-218632, H03-072527, H03-047825, and H08-231707.

The polyoxyalkylene polymer comprising a reactive silicon group may be used singly or in combinations of two or more types.

The backbone of the main chain of the polyoxyalkylene polymer may optionally contain other components, such as a urethane bond component, to the extent that the effects of the present invention are not drastically inhibited thereby.

There is no particular limitation upon the urethane bond component; examples include groups (hereafter also referred to as an amide segment) produced by the reaction of isocyanate groups and active hydrogen groups.

The amide segment is a group represented by general formula (4):

—NR⁵—C(═O)— (4)

(wherein R⁵ is a hydrogen atom or a monovalent organic group, preferably a substituted or unsubstituted monovalent hydrocarbon group comprising 1 to 20 carbon atoms, more preferably a substituted or unsubstituted monovalent hydrocarbon group comprising 1 to 8 carbon atoms).

Specific examples of the amide segment include a urethane group produced by the reaction of an isocyanate group and a hydroxyl group, a urea group produced by the reaction of an isocyanate group and an amino group, and a thiourethane group produced by the reaction of an isocyanate group and a mercapto group. In the present invention, groups produced by the reaction of the active hydrogen in the urethane group, urea group, or thiourethane group with an isocyanate group are also included in the groups represented by general formula (4).

Examples of easily industrially practicable methods of producing a polyoxyalkylene polymer comprising an amide segment and a reactive silicon group include: Examined Japanese Application Publication S46-012154 (U.S. Pat. No. 3,632,557), Unexamined Japanese Patent Application S58-109529 (U.S. Pat. No. 4,374,237), Unexamined Japanese Patent Application S62-013430 (U.S. Pat. No. 4,645,816), Unexamined Japanese Patent Application H08-053528 (EP 0676403), Unexamined Japanese Patent Application H10-204144 (EP 0831108), Japanese Translation of PCT Application 2003-508561(U.S. Pat. No. 6,197,912), Unexamined Japanese Patent Application H06-211879 (U.S. Pat. No. 5,364,955), Unexamined Japanese Patent Application H10-053637 (U.S. Pat. No. 5,756,751), Unexamined Japanese Patent Application H11-100427, Unexamined Japanese Patent Application 2000-169544, Unexamined Japanese Patent Application 2000-169545, Unexamined Japanese Patent Application 2002-212415, Japanese Patent No.3313360, U.S. Pat. Nos. 4,067,844, 3,711,445, Unexamined Japanese Patent Application 2001-323040, Unexamined Japanese Patent Application H11-279249 (U.S. Pat. No. 5,990,257), Unexamined Japanese Patent Application 2000-119365 (U.S. Pat. No. 6,046,270), Unexamined Japanese Patent Application S58-029818 (U.S. Pat. No. 4,345,053), Unexamined Japanese Patent Application H3-047825 (U.S. Pat. No. 5,068,304), Unexamined Japanese Patent Application H11-060724, Unexamined Japanese Patent Application 2002-155145, Unexamined Japanese Patent Application 2002-249538, WO 03/018658, WO 03/059981, Unexamined Japanese Patent Application H6-211879 (U.S. Pat. No. 5,364,955), Unexamined Japanese Patent Application H10-53637 (U.S. Pat. No. 5,756,751), Unexamined Japanese Patent Application H10-204144 (EP 0831108), Unexamined Japanese Patent Application 2000-169544, Unexamined Japanese Patent Application 2000-169545, and Unexamined Japanese Patent Application 2000-119365 (U.S. Pat. No. 6,046,270).

A (meth)acrylic acid ester polymer comprising a reactive silicon group may be added, as necessary, to the curable composition of the present application.

There is no particular limitation upon the (meth)acrylic acid ester monomer constituting the main chain of the (meth)acrylic acid ester polymer; various types can be used. Examples include (meth)acrylate monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxybutyl (meth)acrylate, stearyl (meth)acrylate, glycidyl (meth)acrylate, 2-aminoethyl (meth)acrylate, gamma-(methacryloyloxypropyl) trimethoxysilane, gamma-(methacryloyloxypropyl) dimethoxysilane, methacryoyloxymethyl trimethoxysilane, methacryoyloxymethyl triethoxysilane, methacryoyloxymethyl dimethoxysilane, methacryoyloxymethyl diethoxysilane, an ethylene oxide adduct of (meth)acrylic acid, trifluoromethylmethyl (meth)acrylate, 2-trifluoromethylmethyl (meth)acrylate, 2-perfluoromethylmethyl (meth)acrylate, 2-perfluoroethyl-2-perfluorobutylethyl (meth)acrylate, perfluoroethyl (meth)acrylate, trifluoromethyl (meth)acrylate, bis(trifluoromethyl)methyl (meth)acrylate, 2-trifluoromethyl-2-perfluoroethyl ethyl (meth)acrylate, 2-perfluorohexylethyl (meth)acrylate, 2-perfluorodecylethyl (meth)acrylate, and 2-perfluorohexadecylethyl (meth)acrylate.

In the (meth)acrylic acid ester polymer, the vinyl monomers listed below can be co-polymerized along with the (meth)acrylic acid ester monomer. Examples of the vinyl monomer include: styrene monomers such as styrene, vinyl toluene, alpha-methyl styrene, chlorostyrene, styrene sulfonic acid, and salts thereof; fluorine-containing vinyl monomers such as perfluoroethylene, perfluoropropylene, and vinylidene fluoride; silicon-containing vinyl monomers such as vinyl trimethoxysilane and vinyl triethoxysilane; maleic anhydride, maleic acid, and monoalkyl and dialkyl esters of maleic acid; fumaric acid and monoalkyl and dialkyl esters of fumaric acid; maleimide monomers such as maleimide, methyl maleimide, ethyl maleimide, propyl maleimide, butyl maleimide, hexyl maleimide, octyl maleimide, dodecyl maleimide, stearyl maleimide, phenyl maleimide, and cyclohexyl maleimide; nitrile-group-containing vinyl monomers such as acrylonitrile and methacrylonitrile; amide-group-containing vinyl monomers such as acrylamide and methacrylamide; vinyl esters such as vinyl acetate, vinyl propionate, vinyl pivalate, vinyl benzoate, and vinyl cinnamate; alkenes such as ethylene and propylene; conjugate dienes such as butadiene and isoprene; and vinyl chloride, vinylidene chloride, allyl chloride, and allyl alcohol.

These may be used singly, or a plurality of species may be copolymerized. Of these, polymers of styrene monomers and (meth)acrylic acid monomers are preferable in terms of the physical properties of the product. More preferable are (meth)acrylic acid ester polymers constituted by acrylic acid ester monomers and methacrylic acid ester monomers, with acrylic acid ester polymers constituted by acrylic acid ester monomers being especially preferable. A butyl acrylate monomer is more preferable for general construction uses due to the demand in such uses for physical properties such as low viscosity, low coating modulus, high elongation, weather resistance, and heat resistance. A copolymer primarily constituted by ethyl acrylate is more preferably for uses in which oil resistance is required, such as automobile industrial uses.

Because a polymer constituted primarily by ethyl acrylate will exhibit superior oil resistance but tend to have rather poor low-temperature properties (cold resistance), some of the ethyl acrylate can be substituted by butyl acrylate in order to improve low-temperature properties. However, because satisfactory oil resistance will be lost as the proportion of butyl acrylate increases, this proportion is preferably 40% or less, more preferably 30% or less, in uses requiring oil resistance. It is also preferable to use 2-methoxyethyl acrylate or 2-ethoxyethyl acrylate in which oxygen has been introduced into an alkyl group on a side chain in order to improve low-temperature properties and the like without negatively affecting oil resistance. However, because the introduction of an ether-bond-possessing alkoxy group into a side chain tends to degrade heat resistance, the proportion thereof is preferably 40% or less when heat resistance is necessary. The proportion can be altered for the sake of required physical properties such as oil resistance heat resistance, and low-temperature properties to yield a suitable polymer according to use and purpose.

One non-limiting example of a polymer exhibiting a superior balance of physical properties such as oil resistance, heat resistance, and low-temperature properties is an ethyl acrylate/butyl acrylate/2-methoxyethyl acrylate copolymer (weight ratios: 40-50/20-30/30-20). In the present invention, these preferred monomers may be copolymerized or block-copolymerized with another monomer; in such cases, the content by weight of these preferred monomers is preferably at least 40%. In the expressions used above, (meth)acrylic acid, for example, indicates acrylic acid and/or methacrylic acid.

There is no particular limitation upon the method used to synthesize the (meth)acrylic acid ester polymer; any known method may be used. However, polymers obtained via ordinary free radical polymerization methods using azo compounds, peroxides, and the like as polymerization initiators present the problem of generally having a having molecular weight distribution value of 2 or higher, leading to high levels of viscosity. Therefore, it is preferable to use living radical polymerization in order to obtain a (meth)acrylate ester polymer having a narrow molecular weight distribution and low viscosity, the polymer comprising cross-linkable functional groups in high proportions on the terminals of its molecular chains.

Of the various types of living radical polymerization methods, atom transfer radical polymerization, in which an organic halide or halogenated sulfonyl compound is used as an initiator and a transition metal complex is used as a catalyst to polymerize a (meth)acrylic acid ester monomer, is an even more preferably method of producing a (meth)acrylic acid ester monome comprising a specific functional group, as, in addition to the characteristics of living radical polymerization described above, this method has the features of halogens, which are comparatively advantageous for functional group conversion reactions, being present at the terminal ends, and offering a high level of freedom in the design of the initiator and catalyst. An example of an atom transfer radical polymerization method of this sort is disclosed in Matyjaszewski et al., Journal of the American Chemical Society (J. Am. Chem. Soc.), 1995, vol. 117, p. 5,614.

Examples of producing (meth)acrylic acid ester polymers comprising a reactive silicon group include the chain-transfer-agent-using free radical polymerization methods disclosed in Examined Japanese Patent Application H03-014068, Examined Japanese Patent Application H04-055444, and Unexamined Japanese Patent Application Publication H06-211922. Unexamined Japanese Patent Application Publication H09-272714 and the like disclose methods using atom transfer radical polymerization; however, the present invention is not particularly limited thereto.

The (meth)acrylic acid ester polymer comprising a reactive silicon group may be used singly or in combinations of two or more types.

Unexamined Japanese Patent Application Publications S59-122541, S63-112642, H06-172631, and H11-116763 propose methods for producing organic polyoxyalkylene polymers by blending a polyoxyalkylene polymer comprising a reactive silicon group and a (meth)acrylic acid ester polymer comprising a reactive silicon group; however, the present invention is not particular limited thereto. In a specific preferred example, a polyoxyalkylene polymer comprising a reactive silicon group is blended with a copolymer constituted by a (meth)acrylic acid ester monomer unit comprising a functional group containing 1 to 8 carbon atoms, the unit comprising a reactive silicon group and having a molecular chain substantially represented by general formula (5):

—CH₂—C(R⁶)(COOR⁷)— (5)

(wherein R⁶ is a hydrogen atom or methyl group, and R⁷ is an alkyl group containing 1 to 8 carbon atoms), and a (meth)acrylic acid ester monomer unit comprising an alkyl group containing 10 or more carbon atoms, the unit being represented by the general formula (6):

—CH₂—C(R⁶)(COOR⁸)— (6)

(wherein R⁶ is as described above, and R⁸ is an alkyl group containing 10 or more carbon atoms).

Examples of le in general formula (5) include alkyl groups containing 1 to 8 carbon atoms, preferably 1 to 4 carbon atoms, more preferably 1 to 2 carbon atoms, such as methyl groups, ethyl groups, propyl groups, n-butyl groups, t-butyl groups, and 2-ethylhexyl groups. The alkyl group of R⁷ may be used singly or in combinations of two or more types.

Examples of R⁸ in general formula (6) include alkyl groups containing at least 10 carbon atoms, ordinarily 10 to 30 carbon atoms, preferably 10 to 20 carbon atoms, such as lauryl groups, tridecyl groups, cetyl groups, stearyl groups, and behenyl groups. The alkyl group of R⁸, like that of R⁷, may be used singly or in combinations of two or more types.

The molecular chain of the (meth)acrylic acid ester polymer is substantially constituted by the monomer units of formulas (5) and (6); in this context, “substantially” means that the monomer units of formulas (5) and (6) constitute a total of more than 50% by weight of the copolymer. The total of the monomer units of formulas (5) and (6) is preferably at least 70% by weight.

the ratio of the monomer unit of formula (5) to the monomer unit of formula (6) is preferably 95:5 to 40:60 by weight, preferably 90:10 to 60:40.

Examples of monomer units other than those of formulas (5) and (6) that may optionally be included in the copolymer include: acrylic acids such as acrylic acid and methacrylic acid; monomers containing an amide group such as acrylamide, methacrylamide, and N-methylol methacrylamide, an epoxy group such as glycidyl acrylate or glycidyl methacrylate, or an amino group such as diethylaminoethyl acrylate, diethylaminoethyl methacrylate, or aminoethylvinyl ether; and other monomer units derived from acrylonitrile, styrene, alpha-methyl styrene, alkyl vinyl ether, vinyl chloride, vinyl acetate, vinyl propionate, ethylene, and the like.

Another usable method of producing a polyoxyalkylene polymer by blending a (meth)acrylic acid ester polymer containing a reactive silicon functional group is to polymerize a (meth)acrylic acid ester monomer in the presence of polyoxyalkylene polymer comprising a reactive silicon group. The specific examples of this method are disclosed in Unexamined Japanese Patent Application Publications S59-078223, S59-168014, S60-228516, and S60-228517; however, the present invention is not particularly limited thereto.

A powdered glass filler, i.e., a powdered filler primarily constituted by silicon dioxide (SiO₂), can be used as component (B) of the present invention. Specific examples thereof include fumed silica, precipitated silica, crystalline silica, fused silica, silicic anhydride, silicic acid hydrate, silica gel, silica sand, diatomaceous earth, acidic clay, white carbon, powdered quartz, powdered glass, glass flakes, glass beads, glass filaments, glass fibers, glass roving, glass mats, Shirasu balloons, and glass balloons.

Of these, it is preferable in the present invention to use powdered glass having irregular shapes with sharp raised and processed sections on the surfaces thereof, unlike powdered glass obtained via synthesis that has a roughly spherical shape and smooth surface. Such powdered glass can be obtained, for example, by crushing or pulverizing glass or quartz. The powder preferably has an average particle diameter of 1 μm to 100 μm for the sake of physical properties and workability. A more preferable average particle diameter is 1 μm to 50 μm. Specific examples of these particles include recycled glass fillers such as CF 0002-30 and CF 0017-10B produced by Nippon Frit or CS500 produced by Vitro Minerals, and quartz fillers such as Crystalite A-1 produced by Tatsumori.

Alternatively, needle-shaped or fibrous glass powders having high aspect ratios typified by glass fibers can be preferably used. The powdered glass preferably has a major axis of 1 μm to 100 μm, more preferably 10 μm to 60 μm, for the sake of physical properties and workability. Powders having an aspect ratio of 2 or more and 10 or less are preferable. Specific examples of such powdered glass include EFH 30-01 and EFDE 50-01 produced by Central Glass, and Glass Powder produced by Wako Pure Chemicals.

The amount of component (B) used is preferably 0.01 to 100 parts by weight per 100 parts by weight of the organic polymer comprising a reactive silicon group constituting component (A), preferably 0.02 to 50 parts by weight, more preferably 0.03 to 10 parts by weight, especially preferably 0.03 to 1.5 parts by weight. If the amount exceeds 100 parts by weight, workability may decrease, or the cured product may exhibit insufficient elongation. On the other hand, if the amount is less than 0.01 parts by weight, it will be impossible to obtain the effect of improved weather resistance. The component (B) may be used singly or in combinations of two or more types.

A plasticizer can also be used in the present invention. The addition of a plasticizer allows for the adjustment of mechanical properties such as the viscosity and slump properties of the curable composition, and the hardness, tensile strength, elongation, and the like of the care product obtained by curing the curable composition. Specific examples of plasticizers include: phthalic acid ester compounds such as dibutyl phthalate, diisononyl phthalate (DINP), diheptyl phthalate, di(2-ethylhexyl)phthalate, diisodecyl phthalate (DIDP), and butyl benzyl phthalate; terephthalic acid esters such as bis(2-ethylhexyl)-1,4-benzene dicarbonate (a specific example being Eastman 168™ produced by Eastman Chemical); non-phthalic acid esters such as 1,2-cyclohexane dicarboxylic acid diisononyl ester (a specific example being Hexamoll® DINCH® produced by BASF); aliphatic polyvalent carboxylic acid ester compounds such as dioctyl adipate, dioctyl sebacate, dibutyl sebacate, diisodecyl succinate, and tributyl acetylcitrate; unsaturated fatty acid ester compounds such as butyl oleate and methyl acetylricinoleate; alkyl sulfonic acid phenyl esters (a specific example being Mesamoll® produced by LANXESS); phosphoric acid esters such as tricresyl phosphate and tributyl phosphate; trimellitic acid ester compounds; chlorinated paraffin; hydrocarbon oils such as alkyl diphenyl and partially hydrogenated tar phenyl; and epoxy plasticizers such as epoxylated soybean oil and benzyl epoxystearate.

A high-molecular-weight plasticizer can also be used. Using a high-molecular-weight plasticizer allows initial physical properties to be maintained over longer periods compared to cases in which a low-molecular-weight plasticizer constituted by a plasticizer not containing a polymer component in its molecule is used. The secession classifier also allows drying properties (coating properties) to be improved when an alkyd coating material is applied. Non-limiting specific examples of high-molecular-weight plasticizers include vinyl polymers obtained by polymerizing vinyl monomers according to various methods; esters of polyalkylene glycols such as diethylene glycol dibenzoate, triethylene glycol dibenzoate, and pentaerythritol esters; polyester plasticizers obtained from dibasic acids such as sebacic acid, adipic acid, azelaic acid, and phthalic acid and divalent alcohols such as ethylene glycol, diethylene glycol, triethylene glycol, propylene glycol, and dipropylene glycol; polyether polyols having number-average molecular weights of at least 500, more preferably at least 1000, such as polyethylene glycol, polypropylene glycol, and polytetramethylene glycol, as well as derivatives obtained by substituting the hydroxy groups of these polyether polyols with ester groups, ether groups, and the like; polystyrenes such as polystyrene or poly-alpha-methyl styrene; and polybutadiene, polybutene, polyisobutylene, butadiene-acrylonitrile, and polychloroprene.

Of these high-molecular-weight plasticizers, those that are miscible with organic polymers containing reactive silicon groups are preferable. For these reasons, a polyether or vinyl polymer is preferable. Using a polyether is used as a plasticizer is preferable as surface curability and deep curability will be improved, and delays in curing following storage will not occur, with polypropylene glycol being more preferable. A vinyl polymer is preferable for the sake of miscibility, weather resistance, and heat resistance. Of the various vinyl polymers, acrylic polymers and/or methacrylic polymers are preferable, with acrylic polymers such as polyacrylic acid alkyl esters being more preferable. Living radical polymerization is preferred as the method used to synthesize polymer as it allows for a narrow molecular weight distribution and reduced viscosity, with atom transfer radical polymerization being more preferable. It is also preferable to use a polymer obtained via the SGO process of continuous bulk polymerization of an acrylic acid alkyl ester monomer at high temperature and high pressure disclosed in Unexamined Japanese Patent Application Publication 2001-207157.

The number-average molecular weight of the high-molecular-weight plasticizer is preferably 500 to 15,000, more preferably 800 to 10,000, still more preferably 1000 to 8000, especially preferably 1000 to 5000, and most preferably 1000 to 3000. Too low a molecular weight will cause the plasticizer to bleed out over time as the result of heat or rain, making it impossible to maintain initial physical properties over extended periods of time. Too high a molecular weight will increase viscosity, negatively affecting workability.

There is no particular limitation upon the molecular weight distribution of the high-molecular-weight plasticizer, but the distribution is preferably narrow, and preferably less than 1.80. A distribution of 1.70 or less is more preferable, with 1.60 or less being even more preferable, 1.50 or less being still more preferable, 1.40 or less being especially preferable, and 1.30 or less being most preferable.

The number-average molecular weight of the high-molecular-weight plasticizer is measured via GPC if a vinyl polymer and via end group analysis if a polyether polymer. The molecular weight distribution (Mw/Mn) is measured via GPC (polystyrene standard).

The plasticizer may either comprise or not comprise a reactive silicon group. If the plasticizer comprises a reactive silicon group, the plasticizer functions as a reactive plasticizer, allowing migration of the plasticizer from the cured product to be prevented. If the plasticizer comprises a reactive silicon group, it is preferable for there to be no more than 1 group on average in a single molecule, more preferably 0.8 groups or less.

The amount of plasticizer used is preferably 0 to 100 parts by weight per 100 parts by weight of the organic polymer comprising a reactive silicon group constituting component (A), more preferably 0 to 60 parts by weight. An amount exceeding 40 parts by weight may lead to the problem of insufficient hardness on the part of the cure product. The plasticizer may be used singly or in combinations of two or more types. It is also possible to use a low-molecular-weight plasticizer and a high-molecular-weight plasticizer in combination. These plasticizers may also be added during the production of the polymer.

A filler other than component (B) can also be added to the composition of the present invention.

Examples of fillers include: reinforcing fillers such as fumed silica, precipitated silica, crystalline silica, fused silica, dolomite, silicic anhydride, silicic acid hydrate, and carbon black; fillers such as heavy calcium carbonate, colloidal calcium carbonate, magnesium carbonate, diatomaceous earth, fired clay, clay, talc, titanium oxide, bentonite, organic bentonite, ferric oxide, finally powdered aluminum, powdered flints, zinc oxide, active zinc oxide, Shirasu balloons, glass microballoons, organic microballoons of phenolic resin or vinylidene chloride, and powdered resins such as powdered PVC or powdered PMMA; and fibrous fillers such as filaments. The amount of filler used is preferably 1 to 1000 parts by weight per 100 parts by weight of the organic polymer comprising a reactive silicon group constituting component (A), preferably 10 to 700 parts by weight, more preferably 50 to 500 parts by weight.

If it is intended to entertained a tiered product of high strength through the use of these fillers, a filler primarily selected from fumed silica, precipitated silica, Crystalline silica, fused silica, dolomite, silicic anhydride, silicic acid hydrate, carbon black, surfacen-treated fine calcium carbonate, fired clay, clay, and active zinc oxide is preferable; using an amount thereof of from 1 to 250 parts by weight per 100 parts by weight of the organic polymer comprising a reactive silicon group constituting component (A), preferably 10 to 200 parts by weight, will yield favorable results.

If a cured product of low strength and high break elongation is desired, a filler primarily selected from titanium oxide, heavy calcium carbonate and other calcium carbonates, magnesium carbonate, talc, ferric oxide, zinc oxide, and Shirasu balloons is preferable; an amount thereof of 5 to 1000 parts by weight per 100 parts by weight of the organic polymer comprising a reactive silicon group constituting component (A), preferably 20 to 700 parts by weight, will yield favorable results. In general, the greater the specific surface area of the calcium carbonate is, the greater the improvement in the break strength, brake elongation, and adhesiveness of the cured product will be. Naturally, these fillers may be used singly or in mixtures of two or more types. If calcium carbonate is used, it is preferable to use surface-treated fine calcium carbonate and another type of calcium carbonate having a large particle size, such as heavy calcium carbonate, in combination. The particle diameter of the surface-treated fine calcium carbonate is preferably 0.5 μm or less, and the surface treatment is preferably performed using a fatty acid or fatty acid salt. The large-particle-diameter calcium carbonate preferably has a particle diameter of 1 μm or greater, and need not be surface-treated.

It is preferable to add organic balloons or in organic balloons in order to improve the workability of (spreadability) of the composition and obtain a cured product with a matte surface. The surfaces of these fillers may be treated, and one type there may thereof may be used singly, or a mixture of two types or more may be used. In order to improve workability (spread ability), the particle diameter of the balloons is preferably no more than 0.1 mm. A particle diameter of 5 to 300 μm is preferable in order to yield a cured product with a matte surface.

Balloons are spherical fillers with hollow interiors. Examples of materials for these balloons include inorganic material such as glass, shirasu, and silica, and organic materials such as phenolic resins, urea resins, polystyrene, and Saran; however, the present invention is not limited thereto, and a composite of inorganic and organic materials can be used, or the materials can be layered to form multiple layers. Balloons formed from inorganic materials, organic materials, or a composite thereof can be used. It is possible to use only one type of balloons, or a mixture of multiple types of balloons of different materials. The surfaces of the balloons may be machined or coated, or treated using various types of surface treating agents. For example, organic balloons can be coded with calcium carbonate, talc, titanium oxide, or the like, and inorganic balloons can be surface-treated with an adhesiveness-imparting agent.

Specific examples of balloons are disclosed in Unexamined Japanese Patent Application Publications H02-129262, H04-008788, H04-173867, H05-001225, H07-113073, H09-053063, H10-251618, 2000-154368, and 2001-164237, and WO 97/05201.

A silicate can be used in the composition of the present invention. The silicate functions as a cross-linking agent, and serves to improve the shape restorability, durability, and creep resistance of the organic polymer constituting component (A) of the present invention. The silica also yields the effect of improving adhesiveness, waterproof adhesiveness, and adhesive durability in high-temperature, high-humidity conditions. Tetraalkoxysilane or a partially hydrolyzed condensate thereof can be used as a silicate. If the silicate is used, the amount thereof is preferably 0.1 to 20 parts by weight per 100 parts by weight of the organic polymer constituting component (A), preferably 0.5 to 10 parts by weight.

Specific examples of silicates include tetraalkoxysilanes (tetraalkyl silicates) such as tetramethoxysilane, tetraethoxysilane, ethoxytrimethoxysilane, dimethoxydiethoxysilane, methoxytriethoxysilane, tetra-n-propoxysilane, tetra-i-propoxysilane, tetra-n-butoxysilane, tetra-i-butoxysilane, and tetra-t-butoxysilane, and partially hydrolyzed condensates thereof.

Partially hydrolyzed condensates of tetraalkoxysilanes are more preferable than tetraalkoxysilanes, as they yield greater improvements in the shape restorability, durability, and creep resistance of the present invention.

An example of a partially hydrolyzed condensate of tetraalkoxysilane is one obtained by hydrogenating a tetraalkoxysilane according to an ordinary method, and partially hydrolyzing and condensing the tetraalkoxysilane. It is possible to use a commercially available partially hydrolyzed condensate of an organosilicate compound. Examples of such condensates include methyl silicate 51 and ethyl silicate 40 (both produced by Colcoat Co., Ltd.).

In the present invention, a curing catalyst is used as the silanol condensation catalyst of component (letter A). Specific examples of curing catalysts include: titanium compounds such as tetrabutyl titanate, tetrapropyl titanate, titanium tetrakis(acetylacetonate), bis(acetylacetonate) diisopropoxy titanium, and diisopropoxy titanium bis(ethylacetacetate); tetravalent organic tin compounds such as diemthyltin diacetate, diemthyltin bis(acetylacetonate), dibutyltin dilaurate, dibutyltin maleate, dibutyltin phthalate, dibutyltin dioctanoate, dibutyltin bis(2-ethyl hexanoate), dibutyltin bis(methyl maleate), dibutyltin bis(ethyl maleate), dibutyltin bis(butyl maleate), dibutyltin bis(octyl maleate), dibutyltin bis(tridecyl maleate), dibutyltin bis(benzyl maleate), dibutyltin diacetate, dioctyltin bis(ethyl maleate), dioctyltin bis(octyl maleate), dibutyltin dimethoxide, dibutyltin bis(nonyl phenoxide), dibutenyltin oxide, dibutyltin oxide, dibutyltin bis(acetylacetonate), dibutyltin bis(ethyl acetoacetonate), reaction products of dibutyltin oxide and a silicate compound, reaction products of dibutyltin oxide and a phthalic acid ester, dioctyltin dilaurate, dioctyltin diacetate, and dioctyltin bis(acetylacetonate); organic aluminum compounds such as aluminum tris(acetylacetonate), aluminum tris(ethylacetonate), and diisopropoxyaluminum ethylacetonate; and zirconium compounds such as zirconium tetrakis(acetylacetonate).

A carboxylic acid and/or a carboxylic acid metal salt can also be used as a curing catalyst. An amidine compound such as disclosed in WO 2008/078654 can also be used. Non-limiting examples of amidine compounds include 1-(o-tolyl) biguanide, 1-phenyl guanidine, 1,2-dimethyl-1,4,5,6-tetrahydropyrimidine, 1,5,7-triazabicyclo[4.4.0]deca-5-ene, and 7-methyl-1,5,7-triazabicyclo[4.4.0]deca-5-ene.

The amount of condensation catalyst used is preferably about 0.01 to 20 parts by weight per 100 parts by weight of the organic polymer comprising a reactive silicon group constituting component (A), more preferably 0.1 to 10 parts by weight.

An aminosilane can be added to the curable composition of the present invention. An aminosilane is a compound comprising a reactive silicon group and an amino group and its molecule, and is ordinarily referred to as an adhesiveness-imparting agent. Using an aminosilane allows for dramatic improvement in adhesiveness on various types of substrates, including inorganic substrates such as glass, aluminum, stainless steel, zinc, copper, and mortar, and organic substrates such as vinyl chloride, acrylic, polyester, polyethylene, polypropylene, and polycarbonate, whether in non-primed condition or primer-treated conditions. The effect of improving adhesiveness on various types of substrates is especially prominent in non-primed conditions. Such compounds are also capable of functioning as physical property modification agents and dispersion aids for inorganic fillers.

Specific examples of the reactive silicon group of the aminosilane include those listed above, with a methoxy group, ethoxy group, or the like being preferable for the sake of hydrolysis speed. The number of hydrolyzable groups is preferably 2 or more, especially preferably 3 or more. Specific examples of aminosilanes include amino-group-containing silanes such as gamma-aminopropyl trimethoxysilane, gamma-aminopropyl triethoxysilane, gamma-aminopropyl triisopropoxysilane, gamma-aminopropyl methyldimethoxysilane, gamma-aminopropyl methyldiethoxysilane, gamma-(2-aminoethyl)aminopropyl trimethoxysilane, gamma-(2-aminoethyl)aminopropyl methyldimethoxysilane, gamma-(2-aminoethyl)aminopropyl triethoxysilane, gamma-(2-aminoethyl)aminopropyl methyldiethoxysilane, gamma-(2-aminoethyl)aminopropyl triisopropoxysilane, gamma-(2-(2-aminoethyl)aminoethyl)aminopropyl trimethoxysilane, gamma-(6-aminohexyl)aminopropyl trimethoxysilane, 3-(N-ethylamino)-2-methylpropyl trimethoxysilane, gamma-ureidopropyl trimethoxysilane, gamma-ureidopropyl triethoxysilane, N-phenyl-gamma-aminopropyl trimethoxysilane, N-benzyl-gamma-aminopropyl trimethoxysilane, N-vinylbenzyl-gamma-aminopropyl triethoxysilane, N-cyclohexylaminomethyl triethoxysilane, N-cyclohexylaminomethyl diethoxymethylsilane, N-phenylaminomethyl trimethoxysilane, (2-aminoethyl)aminomethyl trimethoxysilane, and N,N′-bis[3-(trimethoxysilyl)propyl]ethylenediamine; and ketimine silanes such as N-(1,3-dimethylbutylidene)-3-(triethoxysilyl)-1-propaneamine.

Of these, gamma-aminopropyl trimethoxysilane, gamma-(2-aminoethyl)aminopropyl trimethoxysilane, and gamma-(2-aminoethyl)aminopropyl methyl dimethoxysilane are preferable in order to ensure good adhesiveness. The aminosilane may be used singly or in combinations of two or more types. It has been demonstrated that gamma-(2-aminoethyl)aminopropyl trimethoxysilane exhibits more irritation than other aminosilanes; this irritation can be mitigated by using also using gamma-aminopropyl trimethoxysilane instead of reducing the amount of gamma-(2-aminoethyl)aminopropyl trimethoxysilane.

The amount of aminosilane used is preferably about 1 to 20 parts by weight per 100 parts by weight of the organic polymer of component (A), preferably 2 to 10 parts by weight. If the amount is less than 1 part by weight, it may not be possible to obtain sufficient adhesiveness. Conversely, if the amount exceeds 20 parts by weight, the cured product will become brittle and will not be sufficiently strong, and tearing speed may be reduced.

An adhesiveness-imparting-agent other than an aminosilane can be added to the curable composition of the present invention.

Specific examples of adhesiveness-imparting-agents other than aminosilanes include: epoxy-group-containing silanes such as gamma-glycidoxypropyl trimethoxysilane, gamma-glycidoxypropyl triethoxysilane, gamma-glycidoxypropylmethyl dimethoxysilane, beta-(3,4-epoxycyclohexyl)ethyl trimethoxysilane, and beta-(3,4-epoxycyclohexyl)ethyl triethoxysilane; isocyanate-group-containing silanes such as gamma-isocyanatepropyl trimethoxysilane, gamma-isocyanatepropyl triethoxysilane, gamma-isocyanatepropylmethyl diethoxysilane, gamma-isocyanatepropyl methyl dimethoxysilane, (isocyanatemethyl)trimethoxysilane, and (isocyanatemethyl)dimethoxymethylsilane; mercapto-group-containing silanes such as gamma-mercaptopropyl trimethoxysilane, gamma-mercaptopropyl triethoxysilane, gamma-mercaptopropyl methyl dimethoxysilane, gamma-mercaptopropyl methyl diethoxysilane, and mercaptomethyl triethoxysilane; carboxy silanes such as beta-carboxyethyl triethoxysilane, beta-carboxyethylphenyl bis(2-methoxyethoxy)silane, and N-beta-(carboxymethyl)aminoethyl-gamma-aminopropyl trimethoxysilane, vinyl-unsaturated-group-containing silanes such as vinyl trimethoxysilane, vinyl triethoxysilane, gamma-methacryloyloxypropylmethyl dimethoxysilane, and gamma-acryloyloxypropylmethyl triethoxysilane; halogen-containing silanes such as gamma-chloropropyl trimethoxysilane; and isocyanurate silanes such as tris(trimethoxysilyl) isocyanurate.

A condensate obtained by partially condensing the silanes listed above can also be used. It is also possible to use modified derivatives of these, such as amino-modified silyl, silylated amino polymers, unsaturated aminosilane complexes, phenylamino long-chain alkyl silanes, aminosilylated silicone, and silylated polyesters, as silane coupling agents. The amount of silane coupling agent used is ordinarily 0.1 to 20 parts by weight per 100 parts by weight of the organic polymer (A) comprising a reactive silicon group. In particular, an amount in the range of 0.5 to 10 parts by weight is preferable.

The effect of the silane coupling agent added to the curable composition of the present invention is a dramatic improvement in adhesiveness on various types of substrates, including inorganic substrates such as glass, aluminum, stainless steel, zinc, copper, and mortar, and organic substrates such as vinyl chloride, acrylic, polyester, polyethylene, polypropylene, and polycarbonate, whether in non-primed condition or primer-treated conditions. The effect of improving adhesiveness on various types of substrates is especially prominent in non-primed conditions. Non-limiting examples of other additives apart from silane coupling agents include epoxy resins, phenolic resins, sulfur, alkyl titanates, and aromatic polyisocyanates. These adhesiveness-imparting-agents may be used singly or in mixtures of two or more types. The addition of these adhesiveness-imparting-agents allows for improved adhesiveness to substrates.

Of these, gamma-glycidoxypropyl trimethoxysilane, gamma-glycidoxypropyl triethoxysilane, and gamma-glycidoxypropyl methyl dimethoxysilane are preferable in order to ensure good adhesiveness.

The amount of adhesiveness-imparting-agent used is preferably about 0.01 to 20 parts by weight per 100 parts by weight of the organic polymer constituting component pairing A), more preferably about 0.1 to 10 parts by weight, especially preferably 1 to 7 parts by weight.

If the amount of adhesiveness-imparting-agent is less than this range, it may not be possible to obtain sufficient adhesiveness. Conversely, if the amount of adhesiveness-imparting-agent exceeds this range, it may not be possible to obtain deep curability suitable for practical use.

Non-limiting examples of other adhesiveness-imparting-agents apart from those listed above include epoxy resins, phenolic resins, sulfur, alkyl titanates, and aromatic polyisocyanates. These adhesiveness-imparting-agents may be used singly or in mixtures of two or more types. However, because catalytic activity may be reduced depending upon the amounts of epoxy resin added, it is preferable that only a small amount of epoxy resin be added to the curable composition of the present location. The amount of epoxy resin is preferably no more than 5 parts by weight per 100 parts by weight of component (A), more preferably 0.5 parts by weight or less, especially preferably substantially absent.

An antioxidant (anti-aging agent) can be used in the composition obtained according to the present invention. Using an antioxidant allows the heat resistance of the cured product to be increased. Examples of antioxidants include hindered phenols, monophenols, bisphenols, and polyphenols; hindered phenols are especially preferable. Similarly, a hindered amine light stabilizer such as Tinuvin® 622LD, Tinuvin® 144, CHIMASSORB 944LD, and CHIMASSORB 119FL (all obtainable from Ciba Japan), MARK LA-57, MARK LA-62, MARK LA-67, MARK LA-63, and MARK LA-68 (all obtainable from ADEKA), and Sanol LS-770, Sanol LS-765, Sanol LS-292, Sanol LS-2626, Sanol LS-1114, and Sanol LS-744 (all obtainable from Sankyo) can also be used. Specific examples of antioxidants are disclosed in Unexamined Japanese Patent Application Publications H04-283259 and H09-194731. The amount of antioxidant used is preferably 0.1 to 10 parts by weight per 100 parts by weight of the organic polymer (A) comprising a reactive silicon group, more preferably 0.2 to 5 parts by weight.

A light stabilizer can be used in the composition obtained according to the present invention. Using a light stabilizer allows photooxidative degradation of the cured product to be prevented. Examples of light stabilizers include benzotriazoles, hindered amines, and benzoates, with hindered amines being especially preferable. The amount of light stabilizer used is preferably 0.1 to 10 parts by weight per 100 parts by weight of the organic polymer (A) comprising a reactive silicon group, more preferably 0.2 to 5 parts by weight. A specific example of a light stabilizer is disclosed in Unexamined Japanese Patent Application Publication H09-194731.

If a photocurable substance is used along with the composition obtained according to the presence invention, especially if an unsaturated acrylic compound is used, it is preferable to use a hindered amine light stabilizer containing a tertiary amine as a hindered amine light stabilizer, as disclosed in Unexamined Japanese Patent Application Publication H05-070531, in order to improve the storage stability of the composition. Examples of hindered amine light stabilizer containing tertiary amines include Tinuvin® 622LD, Tinuvin® 144, and CHIMASSORB 119FL (all obtainable from Ciba Japan), MARK LA-57, LA-62, LA-67, and LA-63 (all obtainable from ADEKA), and Sanol LS-765, LS-292, LS-2626, LS-1114, and LS-744 (all obtainable from Ciba Japan).

A UV absorber can be used in the composition obtained according to the present invention. Using a UV absorber allows the weather resistance of the surface of the cured product to be increased. Examples of UV absorbers include benzophenones, benzotriazoles, salicylates, substituted tolyls, and metal chelate compounds, with benzotriazoles being especially preferable. The amount of UV absorber used is preferably 0.1 to 10 parts by weight per 100 parts by weight of the organic polymer (A) comprising a reactive silicon group, more preferably 0.2 to 5 parts by weight. It is preferable to use a phenol or hindered phenol antioxidant, a hindered amine light stabilizer, and a benzotriazole UV absorber in combination.

A tackifier can be added to the composition of the present invention. There is no particular limitation upon the tackifier resin; any ordinarily used agent that is solid or liquid at room temperature can be used. Specific examples include styrene block copolymers, hydrogenated thereof, phenol resins, modified phenol resins (for example, cashew-oil-modified phenol resin, tall-oil-modified phenolic resin, etc.), terpene phenol resins, xylene-phenol resins, cyclopentadiene-phenol resins, coumarone-indene resins, rosin-based resins, rosin ester resins, hydrogenated rosin ester resins, xylene resins, low-molecular-weight polystyrene, styrene copolymer resins, petroleum resins (such as C₅ hydrocarbon resins, C₉ hydrocarbon resins, C₅/C₉ copolymer resins, etc.), hydrogenated petroleum resins, terpene resins, DCPD resins, and petroleum resins. These may be used singly or in combinations of two or more types. Examples of styrene block copolymers and hydrogenated versions thereof include styrene-butadiene-styrene block copolymer (SBS), styrene-isoprene-styrene block copolymer (SIS), styrene-ethylene butylene-styrene block copolymer (SEBS), styrene-ethylene propylene-styrene block copolymer (SEPS), and styrene-isobutylene-styrene block copolymer (SIBS). These tackifiers may be used singly or in combinations of two or more types.

5 to 1,000 parts by weight of tackifier per 100 parts by weight of component (A) is used, preferably 10 to 100 parts by weight.

A physical property modifying agent may be added, as necessary, to the curable composition of the present invention in order to modify the tensile properties of the cured product. There is no particular limitation upon the physical property modifying agent; examples include: alkyl alkoxysilanes such as methyl trimethoxysilane, dimethyl dimethoxysilane, trimethyl methoxysilane, and n-propyl trimethoxysilane; alkyl isopropenoxysilanes such as dimethyl diisopropenoxysilane, methyl triisopropenoxysilane, gamma-glycidoxypropyl methyldiisopropenoxysilane, and functional-group-comprising alkoxysilanes such as gamma-glycidoxypropyl methyl dimethoxysilane, gamma-glycidoxypropyl trimethoxysilane, vinyl trimethoxysilane, vinyldimethyl methoxysilane, gamma-aminopropyl trimethoxysilane, N-(beta-aminoethyl)aminopropylmethyl dimethoxysilane, gamma-mercaptopropyl trimethoxysilane, and gamma-mercaptopropyl methyl dimethoxysilane; silicone varnishes; and polysiloxanes. Using the physical property modifying agent allows hardness to be increase when the composition of the present invention has been cured, or, conversely, hardness to be reduced and break elongation to be increased. This physical property modifying agent may be used singly or in combinations of two or more types.

In particular, a compound that produces a compound comprising a monovalent silanol group in its molecule as the result of hydrolysis allows the modulus of the cured product to be reduced without negatively affecting the tackiness of the surface of the cured product. A compound that produces trimethylsilanol is especially preferable. An example of a compound that produces a compound comprising a monovalent silanol group in its molecule as the result of hydrolysis is the compound disclosed in Unexamined Japanese Patent Application Publication H05-117521.

Other examples include compounds that are derivatives of alkyl alcohols such as hexanol, octanol, and decanol and produce silicon compounds that produce R³SiOH such as trimethyl silanol via hydrolysis, and to the compounds, disclosed in Unexamined Japanese Patent Application Publication H11-241029, that are derivatives of poly hydric alcohols comprising three or more hydroxy groups such as pentaerythritol or sorbitol and produce R³SiOH such as trimethyl silanol as the result of hydrolysis.

Another example is compounds that are derivatives of oxypropylene polymers and produce silicon compounds that produce R³SiOH such as trimethyl silanol as a result of hydrolysis such as those disclosed in Unexamined Japanese Patent Application Publication H07-258534. The polymer comprising a cross-linkable reactive-silicon-containing group and a silicon-containing group that is capable of forming a monosilanol-containing compound as the result of hydrolysis disclosed in Unexamined Japanese Patent Application Publication agent 06-279693 can also be used.

The amount used of physical property modifying agent is 0.1 to 20 parts by weight per 100 parts by weight of the organic polymer (A) comprising a reactive silicon group, preferably 0.5 to 10 parts by weight.

A thixotropic agent (anti-dripping agent) can be added, as appropriate, to the curable composition of the present invention in order to prevent dripping and improve workability. There is no particular limitation upon the anti-dripping agent; examples include polyamide waxes, hydrogenated castor oil derivatives, and metal soaps such as calcium stearate, aluminum stearate, and barium stearate. Using powdered rubber having a particle diameter of 10 to 500 μm such as disclosed in Unexamined Japanese Patent Application Publication H11-349916 or organic fibers such as disclosed in Unexamined Japanese Patent Application Publication 2003-155389 yields a compound that exhibits high levels of thixotropy and good workability. These thixotropic agents (anti-dripping agents) may be used singly or in combinations of two or more types. 0.1 to 20 parts by weight of thixotropic agent is used per 100 parts by weight of component (A).

A compound comprising an epoxy group within a single molecule can be used in the composition of the present invention. Using a compound comprising an epoxy group allows the shape restorability of the cured product to be increased. Examples of compounds comprising epoxy groups include epoxylated unsaturated oils, epoxylated unsaturated fatty acid esters, cycloaliphatic epoxy compounds, compounds seen in epichlorohydrin derivatives, and mixtures thereof. Specific examples include epoxylated soybean oil, epoxylated linseed oil, bis(2-ethylhexyl)-4,5-epoxycyclohexane-1,2-dicarboxylate (E-PS), epoxyoctyl stearate, and epoxybutyl stearate. Of these, E-PS is especially preferable. The amount of epoxy compound used is preferably 0.5 to 50 parts by weight per 100 parts by weight of the organic polymer (A) comprising a reactive silicon group.

A photocurable substance can be used in the composition of the present invention. Using the photo curable substance causes a coding of photo curable substance to form on the surface of the cured product, thereby decreasing the tackiness of the cured product and improving weather resistance. A photo curable substance is a substance the molecular structure of which undergoes chemical changes in a comparatively short time as a result of the action of light, producing physical changes such as curing. Numerous types of such compounds are known, including organic monomers, oligomers, resins, and compositions containing the same; any commercially available preparation of these can be used. An unsaturated acrylic compound, a vinyl polycinnamate, an azide resin, or the like can be used as a typical example. Examples of unsaturated acrylic compounds include monomers and oligomers containing one or multiple acrylic or methacrylic unsaturated groups, as well as mixtures thereof, monomers such as propylene (or butylene or ethylene) glycol di(meth)acrylate and neopentylglycol di(meth)acrylate, and oligoesters having a molecular weight of 10,000 or less. Specific examples include the special acrylates Aronix M-210, Aronix M-215, Aronix M-220, Aronix M-233, Aronix M-240, Aronix M-245 (difunctional); Aronix M-305, Aronix M-309, Aronix M-310, Aronix M-315, Aronix M-320, Aronix M-325 (trifunctional); and Aronix M-400 (polyfunctional) (all obtainable from Toagosei). A compound comprising an acrylic functional group is especially preferable, as is a compound comprising an average of three or more identical functional groups in a single molecule.

Examples of vinyl polycinnamates include photosensitive resins comprising a cinnamoyl group as a photosensitive group that are obtained by esterifying a polyvinyl alcohol with cinnamic acid, as well as other vinyl polycinnamate derivatives. Azide resins are known as photosensitive resins that comprise an azide group as a photosensitive group. Along with the ordinary use of diazide compounds in photosensitive rubber liquids as photosensitizing agent, “Kankosei Jushi” [“Photosensitive Resins”] (Mar. 17, 1972, Insatsu Gakkai Shuppanbu; pages 93, 106, 117) lists specific examples of these resins, which may be added or in mixtures as sensitizers, as necessary. Adding a sensitizer such as a ketone or nitro compound or an accelerator such as an amine may increase effectiveness. The amount of photocurable substance may be used in an amount from 0.1 to 20 parts by weight per 100 parts by weight of the organic polymer (A) comprising the reactive silicon group, preferably 0.5 to 10 parts by weight. An amount less than 0.1 parts by weight will not yield the effect of increasing weather resistance, and an amount exceeding 20 parts by weight will cause the cured product to become too hard, leading to a tendency for cracks to form.

An oxygen-curable substance can be used in the composition of the present invention. Examples of oxygen-curable substances include unsaturated compounds that are capable of reacting with oxygen in the air, and serve to react with the oxygen in the air and form a hardened film near the surface of the cured product, thereby preventing surface tackiness, the adhesion of dust or dirt on the surface of the cured product, and so forth. Specific examples of oxygen-curable substances include: dry oils typified by tung oil and linseed oil, as well as various alkyd resins that can be obtained by modifying these compounds; acrylic polymers, epoxy resins, and silicon resins modified using a dry oil; and liquid polymers such as 1,2-polybutadiene, 1,4-polybutadiene, and C₅ to C₈ diene polymers obtained by polymerizing or copolymerizing a diene compound such as butadiene, chloroprene, isoprene, or 1,3-pentadiene, liquid copolymers such as NBR and SBR that can be obtained by copolymerizing along with monomers such as acrylonitrile and styrene that are copolymerizable with these diene compounds so that the diene compound is the primary constituent thereof, and modified versions thereof (maleic-acid-modified, boiled-oil-modified, etc.). These may be used singly or in combinations of two or more types. Of these, tung oil and liquid diene polymers are especially preferable. The concurrent use of a catalyst or metal drying agent that promotes oxidative curing reactions may enhance effects. Examples of such catalysts and metal drying agents include metal salts such as cobalt naphthenate, lead naphthenate, zirconium naphthenate, cobalt octylate, and zirconium octylate, and amine compounds. The amount of oxygen-curable substance used is preferably 0.1 to 20 parts by weight per 100 parts by weight of the organic polymer (A) comprising a reactive silicon group, more preferably 0.5 to 10 parts by weight. If the amount is less than 0.1 parts by weight, there will be insufficient improvement in contaminativity; if the amount exceeds 20 parts by weight, there is a tendency for the tensile properties of the cured product to be negatively affected. As disclosed in Unexamined Japanese Patent Application Publication H03-160053, an oxygen-curable substance is preferably used in tandem with a photocurable substance.

A phosphate plasticizer such as ammonium polyphosphate or tricresyl phosphate, or a flame retardant such as aluminum hydroxide, magnesium hydroxide, or thermally expandable graphite can be added to the curable composition of the present invention. These flame retardants may be used singly or in combinations of two or more types.

5 to 200 parts by weight of flame retardant per 100 parts by weight of component is used, preferably 10 to 100 parts by weight.

Various additives may be added, as necessary, to the curable composition of the present invention in order to adjust the physical properties of the curable composition or the cured product. Examples of such additives include curability adjusters, radical inhibitors, metal deactivators, ozone degradation inhibitors, phosphate peroxide decomposers, lubricants, pigments, foaming agents, ant repellents, antifungal agents, and the like. These additives may be used singly or in combinations of two or more types. Specific examples of additives other than the specific examples listed herein are disclosed in, for example, Examined Japanese Patent Application H04-069659, Examined Japanese Patent Application H07-108928, Unexamined Japanese Patent Application Publication S63-254149, Unexamined Japanese Patent Application Publication S64-022904, and Unexamined Japanese Patent Application Publication 2001-072854.

The curable composition of the present invention can also be prepared in a single-pack form by storing all of the components in a sealed container so that the composition cares upon contact with humidity in the air following application, or in a two-pact form in which components such as curing catalysts, fillers, plasticizers, and water are separately prepared as curing agents, and mixed with the polymer composition prior to use. A one-pack preparation is preferable for the sake of workability.

If the curable composition is prepared in a one-pack form, all of the components are added in advance; thus, it is preferable to first dehydrate and desecrate any components containing water prior to use, or to vacuum-dehydrate these components during mixing. If the curable composition is prepared in a two-pack form, because there is no need to add the curing catalyst to the primary agent containing the polymer comprising the reactive silicon group, there is no risk of the composition forming a gel even if slight amounts of moisture are present they are in; however, it is preferable to dehydrate and desecrate the composition if long-term storage stability is necessary. Preferred methods of dehydration and desiccation include heat drying or vacuum dehydration if the composition is a solid form such as powder, and vacuum dehydration or dehydration using synthetic zeolite, active alumina, silica gel, quicklime, magnesium oxide, or the like if the composition is in liquid form. In addition to the dehydration and desiccation methods described above, dehydration may be performed by adding an alkoxysilane compound such as n-propyl trimethoxysilane, vinyl trimethoxysilane, vinylmethyl dimethoxysilane, methyl silicate, ethyl silicate, gamma-mercaptopropylmethyl dimethoxysilane, gamma-mercaptopropylmethyl diethoxysilane, or gamma-glycidoxypropyl trimethoxysilane and reacting the water therewith. Dehydration may also be performed by adding an oxazolidine compound such as 3-ethyl-2-methyl-2-(3-methylbutyl)-1,3-oxazolidine and reacting the water therewith. Dehydration may also be performed by adding small amounts of an isocyanate compound and reacting the isocyanate groups therein with the water. Storage stability can be improved through the addition of an alkoxysilane compound, an oxazolidine compound, or an isocyanate compound.

The amount of dehydrating agent, especially a silicon compound capable of reacting with water, such as vinyl trimethoxysilane, is preferably 0.1 to 20 parts by weight per 100 parts by weight of the organic polymer (A) comprising a reactive silicon group, more preferably 0.5 to 10 parts by weight.

There is no particular limitation upon the method used to prepare the curable composition of the present invention; for example, in ordinary methods such as adding and mixing the components at ambient temperature or while being heated using a mixer, roller, neater, or the like, or using small amounts of a suitable solvent to dissolve the components, which are then mixed, can be used.

The cable composition of the present invention forms a three-dimensional network through the action of moisture upon exposure to the atmosphere, curing into a rubber-like elastic solid.

The curable composition of the present invention can be used in an adhesive, flooring adhesive, tiling adhesive, coaching material, glue, molding agent, vibration isolation material, damping material, sound insulation, foam material, paint, spray material, or the like.

The composition can also be used in various applications, such as electrical and electronic component materials such as solar cell backing sealants, electrical insulation materials such as insulating coatings for electrical wires and cables, elastic adhesives, contact adhesives, spray sealants, crack mending materials, tiling adhesives, powdered paints, mold injection materials, medical rubber materials, medical adhesives, medical device sealant materials, food packaging materials, joint sealing materials for external material such as siding, primers, electroconductive materials for electromagnetic shielding, thermal conductive materials, hot melt materials, electrical and electronic potting materials, films, gaskets, various types of building materials, rust-preventing/waterproofing sealants for end surfaces (cut sections) of wired glass or laminated glass, and liquid sealing materials used in automobile parts, electronic components, and components for various types of machinery. In addition, the composition is capable of bonding to bond to a wide range of substrates, such as glass, porcelain, wood, metal, and molded resin, alone or with the help of a primer, allowing the composition to be used as various types of sealing compositions and adhesive compositions. The curable composition of the present invention can also be used as an adhesive for interior panels, an adhesive for exterior panels, a stone adhesive, a ceiling finishing adhesive, a floor finishing adhesive, a wall finishing adhesive, and automobile panel adhesive, or an adhesive for assembling electrical, electronic, or precision devices.

### EXAMPLES

The present invention will now be described in further detail with the aid of specific working examples; however, the present invention is not limited to the working examples described hereafter.

### Synthesis Example 1 (A-1)

Using polyoxypropylene triol having a number-average molecular weight of roughly 3,000 as an initiator, propylene oxide polymerization was performed using a zinc hexacyanocabaltate-glyme complex catalyst to obtain a polyoxypropylene triol having a number-average molecular weight of 16,400 (polystyrene-standard molecular weight as measured using a Tosoh HLC-8120 GP fluid delivery system, a Tosoh TSK-GEL H-type column, and THF as a solvent). Next, an amount of a NaOMe methanol solution equivalent to 1.2 equivalent weight of the hydroxyl groups of the hydroxyl-group-capped polyoxypropylene triol was added and the methanol was distilled away, after which 3-chloro-1-propene was added to convert the terminal hydroxyl groups to allyl groups. Next, 36 ppm of a platinum/divinyl disiloxane complex (3 wt % isopropanol solution in terms of platinum) was added to 100 parts by weight of the obtained allyl-group-capped polyoxypropylene, and 1.78 parts by weight dimethoxymethylsilane was slowly added drop-wise thereto while the mixture was stirred. After reacting the mixed solution at 90° C. for two hours, the unreacted dimethoxymethylsilane was vacuum-distilled away to obtain a reactive-silicon-group-containing polyoxypropylene polymer (A-1) capped with dimethoxymethylsilyl groups, the polymer comprising an average of 2.2 silicon atom groups per molecule and having a number-average molecular weight of 16,400.

### Synthesis Example 2 (A-2)

Using polyoxypropylenediol having a molecular weight of about 3,000 as an initiator, propylene oxide polymerization was performed using a zinc hexacyanocobaltate-glyme complex catalyst to obtain a hydroxyl-group-capped difunctional polypropylene oxide polymer having a number-average molecular weight of about 25,500. Next, an amount of a NaOMe methanol solution equivalent to 1.2 equivalent weight of the hydroxyl groups of the hydroxyl-group-capped polyoxypropylene triol was added and the methanol was distilled away, after which 3-chloro-1-propene was added to convert the terminal hydroxyl groups to allyl groups. Next, 36 ppm of a platinum/divinyl disiloxane complex (3 wt % isopropanol solution in terms of platinum) was added to 100 parts by weight of the obtained allyl-group-capped polyoxypropylene, and 0.91 parts by weight dimethoxymethylsilane was slowly added drop-wise thereto while the mixture was stirred. After reacting the mixed solution at 90° C. for two hours, the unreacted dimethoxymethylsilane was vacuum-distilled away to obtain a reactive-silicon-group-containing polyoxypropylene polymer (A-2) capped with dimethoxymethylsilyl groups, the polymer comprising an average of 1.4 silicon atom groups per molecule and having a number-average molecular weight of 25,500.

### Synthesis Example 3 (A-3)

Using polyoxypropylenediol having a molecular weight of about 3,000 as an initiator, propylene oxide polymerization was performed using a zinc hexacyanocobaltate-glyme complex catalyst to obtain a hydroxyl-group-capped difunctional polypropylene oxide polymer having a number-average molecular weight of about 16,200. Next, an amount of a NaOMe methanol solution equivalent to 1.2 equivalent weight of the hydroxyl groups of the hydroxyl-group-capped polyoxypropylene triol was added and the methanol was distilled away, after which 3-chloro-1-propene was added to convert the terminal hydroxyl groups to allyl groups. Next, 36 ppm of a platinum/divinyl disiloxane complex (3 wt % isopropanol solution in terms of platinum) was added to 100 parts by weight of the obtained allyl-group-capped polyoxypropylene, and 1.30 parts by weight dimethoxymethylsilane was slowly added drop-wise thereto while the mixture was stirred. After reacting the mixed solution at 90° C. for two hours, the unreacted dimethoxymethylsilane was vacuum-distilled away to obtain a reactive-silicon-group-containing polyoxypropylene polymer (A-3) capped with dimethoxymethylsilyl groups, the polymer comprising an average of 1.2 silicon atom groups per molecule and having a number-average molecular weight of 16,200.

### Synthesis Example 4 (A-4)

Using both polyoxypropylenediol having a molecular weight of about 3,000 and polyoxypropylene triol having a molecular weight of about 3,000 as initiators, propylene oxide polymerization was performed using a zinc hexacyanocobaltate-glyme complex catalyst to obtain a hydroxyl-group-capped difunctional polypropylene oxide polymer having a number-average molecular weight of about 19,700. Next, an amount of a NaOMe methanol solution equivalent to 1.2 equivalent weight of the hydroxyl groups of the hydroxyl-group-capped polyoxypropylene triol was added and the methanol was distilled away, after which 3-chloro-1-propene was added to convert the terminal hydroxyl groups to allyl groups. Next, 36 ppm of a platinum/divinyl disiloxane complex (3 wt % isopropanol solution in terms of platinum) was added to 100 parts by weight of the obtained allyl-group-capped polyoxypropylene, and 1.34 parts by weight dimethoxymethylsilane was slowly added drop-wise thereto while the mixture was stirred. After reacting the mixed solution at 90° C. for two hours, the unreacted dimethoxymethylsilane was vacuum-distilled away to obtain a reactive-silicon-group-containing polyoxypropylene polymer (A-4) capped with dimethoxymethylsilyl groups, the polymer comprising an average of 1.7 silicon atom groups per molecule and having a number-average molecular weight of 19,700.

### Working Example 1

210 parts by weight of fatty-acid-treated heavy calcium carbonate (trade name: NCC-2510; produced by Formosa), 20 parts by weight of a pigment (trade name: Tipaque® R820; produced by Ishihara Sangyo), 2 parts by weight of a thixotropic agent (trade name: Crayvallac SL; produced by Cray Valley), 1 part by weight powdered silica (trade name: Aerosil R974; produced by Evonik), 1 part by weight of a light stabilizer (trade name: LS-770; produced by BASF), 1 part by weight of a UV absorber (trade name: Tinuvin 326; produced by BASF), 0.04 parts by weight powdered glass (trade name: Glass Powder; produced by Wako Pure Chemicals), 2 parts by weight vinyl trimethoxysilane (trade name: A-171; produced by Momentive), 3 parts by weight N-(2-aminoethyl)-3-aminopropyl trimethoxysilane (trade name: A-1122; produced by Momentive), and 2 parts by weight dibutyltin bis(acetylacetonate) (trade name: U220H; produced by Nitto Kasei) as a condensation catalyst were weighed out per 30 parts by weight of polymer (A-1) and 70 parts by weight of polymer (A-2), and the mixture was needed using the mixer in dehydrating conditions in a substantially water-free state, then sealed in a humidity-proof container (polyethylene cartridge) to obtain a single-pack curable composition.

### Comparative Example 1

A single-pack curable composition was prepared and obtained according to a method similar to that of working example 1, except that the 0.04 parts by weight of powdered glass (trade name: Glass Powder; produced by Wako Pure Chemicals) was omitted.

### Working Example 2

160 parts by weight fatty-acid-treated colloidal calcium carbonate (trade name: Hakuenka CCR; produced by Shiraishi Kogyo), 54 parts by weight heavy calcium carbonate (trade name: LM220; produced by Maruo Calcium), 90 parts by weight of a phthalic acid ester plasticizer (trade name: DIDP; produced by J-PLUS), 20 parts by weight of a pigment (trade name: Tipaque® R820; produced by Ishihara Sangyo), 2 parts by weight of a thixotropic agent (trade name: Crayvallac SL; produced by Cray Valley), 1 part by weight of a light stabilizer (trade name: LS-770; produced by BASF), 1 part by weight of a UV absorber (trade name: Tinuvin 326; produced by BASF), 1 part by weight of recycled powdered glass (trade name: CF0002-30; produced by Nippon Frit), 2 parts by weight vinyl trimethoxysilane (trade name: A-171; produced by Momentive), 3 parts by weight N-(2-aminoethyl)-3-aminopropyl trimethoxysilane (trade name: A-1122; produced by Momentive), and 2 parts by weight dibutyltin bis(acetylacetonate) (trade name: U220H; produced by Nitto Kasei) as a condensation catalyst were weighed out per 30 parts by weight of polymer (A-3) and 70 parts by weight of polymer (A-4), and the mixture was needed using the mixer in dehydrating conditions in a substantially water-free state, then sealed in a humidity-proof container (polyethylene cartridge) to obtain a single-pack curable composition.

### Working Example 3

A single-pack curable composition was prepared and obtained according to a method similar to that used for working example 2, except that 1 part by weight recycled powdered glass (trade name: CF0017-10B; produced by Nippon Frit) was substituted for the 1 part by weight of recycled powdered glass (trade name: CF0002-30; produced by Nippon Frit).

### Working Example 4

A single-pack curable composition was prepared and obtained according to a method similar to that used for working example 2, except that 1 part by weight quartz filler (trade name: Crystalite A-1; produced by Tatsumori) was substituted for the 1 part by weight of recycled powdered glass (trade name: CF0002-30; produced by Nippon Frit).

### Working Example 5

A single-pack curable composition was prepared and obtained according to a method similar to that used for working example 2, except that 1 part by weight powdered glass (trade name: Glass Powder; produced by Wako Pure Chemicals) was substituted for the 1 part by weight of recycled powdered glass (trade name: CF0002-30; produced by Nippon Frit).

### Working Example 6

A single-pack curable composition was prepared and obtained according to a method similar to that used for working example 2, except that 1 part by weight glass fiber powder (trade name: EFDE 30-01; produced by Central Glass) was substituted for the 1 part by weight of recycled powdered glass (trade name: CF0002-30; produced by Nippon Frit).

### Working Example 7

A single-pack curable composition was prepared and obtained according to a method similar to that used for working example 2, except that 1 part by weight glass fiber powder (trade name: EFDE 50-01; produced by Central Glass) was substituted for the 1 part by weight of recycled powdered glass (trade name: CF0002-30; produced by Nippon Frit).

### Comparative Example 2

A single-pack curable composition was prepared and obtained according to a method similar to that used for working example 2, except that 1 part by weight fumed silica (trade name: Aerogel R974; produced by Evonik) was substituted for the 1 part by weight of recycled powdered glass (trade name: CF0002-30; produced by Nippon Frit).

### Comparative Example 3

A single-pack curable composition was prepared and obtained according to a method similar to that used for working example 2, except that 1 part by weight glass balloons (trade name: Glass Balloons K15; produced by 3M) was substituted for the 1 part by weight of recycled powdered glass (trade name: CF0002-30; produced by Nippon Frit).

### Comparative Example 4

A single-pack curable composition was prepared and obtained according to a method similar to that used for working example 2, except that the 1 part by weight of recycled powdered glass (trade name: CF0002-30; produced by Nippon Frit) was omitted.

### [Evaluation]

The hardness of the prepared compositions was measured according to the following method.

### (Viscosity, Ratio of Viscosity)

Viscosity was measured at speeds of 1 rpm, 2 rpm, and 10 rpm using a Toki Sangyo BS-type viscometer, rotor No. 7, in atmospheric conditions of 22° C. and 50% relative humidity, and the ratio of viscosity at 2 rpm and 10 rpm was measured as an indicator of thixotropy.

### (Tensile Properties)

The single-pack curable composition was used to fill a 3 mm-thick polyethylene mold in atmospheric conditions of 23° C. and 50% relative humidity while ensuring that air bubbles did not form, and the composition was cured for three days at 23° C. and 50% relative humidity, followed by four days at 50° C. to obtain a cured product. A #3 dumbbell was punched from the obtained cured product according to JIS K 6251, and tensile testing (strain rate: 200 mm/minute; 22° C.; 50% relative humidity) was performed to measure the modulus at 100% elongation (M100), break strength (TB), and break elongation (EB).

### (Weather Resistance Measurement)

A 3 mm-thick sheet of cured product was prepared according to a method similar to that used for the tensile properties evaluation described above. Accelerated weathering of the sheet was performed using a sunshine weather meter, and visual observation was performed to determine the length of time until cracks formed in the surface of the cured product.

A 200 mm-thick sheet of cured product was prepared accord to a similar method, and similarly subjected to accelerated weathering using a sunshine weather meter. The crack state of the surface after 240 hours was observed and rated according to the following criteria.

5: No abnormalities; 4: Fine cracks; 3: Cracks present; 2: Deep cracks; 1: Breakdown; 5 (Good)>4>3>2>1 (Degradation)

### Working example 1, Comparative Example 1

TABLE 1

| | | | | | Comparative |
|---|---|---|---|---|---|
| | | | | Example 1 | example 1 |
| glass powder | | | | yes | no |
| viscosity | 1 | rpm | Pa · s | 2460 | 3012 |
| (23° C., BS type viscometer, | 2 | rpm | Pa · s | 1416 | 1722 |
| Rotor No. 7) | 10 | rpm | Pa · s | 461 | 529 |

| Viscosity ratio (2 rpm/10 rpm) | 2 rpm/10 rpm | | 3.07 | 3.25 |
|---|---|---|---|---|
| Dumbbell property | M100 | MPa | 0.48 | 0.44 |
| JIS K 6251 No. 3 dumbbell | Tb | MPa | 1.67 | 1.75 |
| | Eb | % | 949 | 930 |

| | | |
|---|---|---|
| Weatherability (by carbon arc; SWM) | 2500-2900 hr | 1500-2000 hr |
| time to start cracking | | |

As is apparent from the results shown in table 1, a comparison of working example 1 and comparative example 1 shows that the curable composition containing the silicon-based filler exhibited workability and dynamic properties comparable to those of the curable composition of the comparative example, and exhibited superior surface weather resistance. In particular, the powdered glass used in working example 1 yielded great effects in extending the time until weathering cracks formed in the surface to nearly 1,000 hours despite only a quite small amount thereof (0.04 parts by weight) being added to 100 parts by weight of component (A).

### Working Examples 2˜7, Comparative Examples 2˜4

TABLE 2

| | | | | | | | | Comparative | Comparative | Comparative |
|---|---|---|---|---|---|---|---|---|---|---|
| sample | | Example 2 | Example 3 | Example 4 | Example 5 | Example 6 | Example 7 | example 2 | example 3 | example 4 |
| | | CF0002-30 | CF0017-10B | Crystallites | Glass | EFH30-01 | EFDE50-01 | AEROGEL | Glass | no add |
| | | | | A-1 | Powder | | | R974 | Bubbles | |
| | | | | | | | | | K15 | |
| | | glass powder | | Quarts | Glass | glass fiber powder | | silica | balloon | |
| | | | | filler | Powder | | | | | |
| perticle size (μm) | | 30 | 10 | 11 | — | 30/11 | 50/6 | 0.016 | 60 | |
| length (μm) | | | | | | | | | | |
| Viscosity | 2 rpm | 476 | 468 | 454 | 477 | 465 | 472 | 542 | 497 | 483 |
| | 10 rpm | 162 | 157 | 151 | 160 | 156 | 160 | 180 | 174 | 163 |
| | 2 rpm/ | 2.94 | 2.98 | 3.01 | 2.98 | 2.98 | 2.95 | 3.01 | 2.86 | 2.97 |
| | 10 rpm | | | | | | | | | |
| Dumbbell | M50 | 0.31 | 0.32 | 0.31 | 0.30 | 0.33 | 0.31 | 0.31 | 0.31 | 0.30 |
| physical | M100 | 0.56 | 0.57 | 0.56 | 0.55 | 0.59 | 0.57 | 0.58 | 0.58 | 0.55 |
| properties | TB | 1.43 | 1.54 | 1.54 | 1.44 | 1.46 | 1.45 | 1.47 | 1.40 | 1.42 |
| | EB | 500 | 527 | 548 | 495 | 490 | 527 | 496 | 465 | 510 |
| weaterability | 200 μ | 3 | 4 | 4 | 3 | 3 | 4 | 1 | 1 | 2 |
| (240 Hr) | | | | | | | | | | |

As is apparent from the results shown in table 2, a comparison of working examples 2˜3, which used crushed powdered glass, working examples 6˜7, which used glass fiber powder, and comparative examples 2˜4 shows that there was no reduction in viscosity or mechanical properties, and superior surface weather resistance was exhibited.

1. A curable composition, comprising:
(A) at least one reactive-silicon-group-containing polyoxyalkylene polymer which has a number-average molecular weight of from 2,000 to 50,000 and includes from 1.1 to 5 reactive silicon groups within a single molecule; and
(B) from 0.01 to 100 parts by weight of at least one powdered-glass-based filler based on 100 parts by weight of the at least one reactive-silicon-group-containing polyoxyalkylene polymer (A).

2. The curable composition according to claim 1, wherein the at least one powdered-glass-based filler (B) comprises particles having sharp, irregular raised and recessed sections on the surfaces of the particles, or particles having needle-like or fiber-like shapes.

3. The curable composition according to claim 2, wherein the at least one powdered-glass-based filler (B) comprises particles having sharp, irregular raised and recessed sections on the surfaces, and an average particle diameter of the particles having sharp raised and recessed sections on the surfaces is from 1 μm to 100 μm.

4. The curable composition according to claim 2, wherein the at least one powdered-glass-based filler (B) comprises particles having needle-like or fiber-like shapes, and a major axis of the needle- or fiber-like particles is from 1 μm to 100 μm.

5. The curable composition according to claim 1, wherein an amount of the at least one powdered-glass-based filler (B) is from 0.03 to 10 parts by weight per 100 parts by weight of the at least one reactive-silicon-group-containing polyoxyalkylene polymer (A).

6. The curable composition according to claim 3, wherein the average particle diameter of the particles having sharp raised and recessed sections on the surfaces is from 1 μm to 50 μm.

7. The curable composition according to claim 4, wherein the major axis of the needle- or fiber-like particles is from 10 μm to 60 μm.

8. The curable composition according to claim 5, wherein the at least one powdered-glass-based filler (B) comprises particles having needle-like or fiber-like shapes, and the needle- or fiber-like particles have an aspect ratio of from 2 to 10.

9. The curable composition according to claim 1, wherein the reactive-silicon-group-containing polyoxyalkylene polymer (A) comprises at least one hydroxyl group, at least one hydrolyzable group or a combination thereof, bonded to at least one silicon atom.

10. The curable composition according to claim 1, wherein the reactive-silicon-group-containing polyoxyalkylene polymer (A) comprises at least one hydrolyzable group selected group the group consisting of a hydrogen atom, a halogen atom, an alkoxy group, an acyloxy group, a ketoximate group, an amino group, an amide group, an acid amide group, an aminooxy group, a mercapto group, and an alkenyloxy group.

11. The curable composition according to claim 1, wherein the reactive-silicon-group-containing polyoxyalkylene polymer (A) includes a reactive silicon group of the formula (1):
—SiR¹₃₋ₐXₐ (1),
wherein R¹ is an alkyl group comprising 1 to 20 carbon atoms, an aryl group comprising 6 to 20 carbon atoms, an aralkyl group comprising 7 to 20 carbon atoms, or a triorganosiloxy group represented by (R′)₃SiO—, wherein each R′ independently is a substituted or unsubstituted hydrocarbon group comprising 1 to 20 carbon atoms; each X independently is a hydroxyl group or a hydrolyzable group; and a is 1, 2, or 3.

12. The curable composition according to claim 1, wherein the number-average molecular weight of the at least one reactive-silicon-group-containing polyoxyalkylene polymer is from 3,000 to 30,000.

13. The curable composition according to claim 1, wherein the polyoxyalkylene polymer comprises a repeating unit of the formula (3):
—R⁴—O— (3),
wherein R⁴ is a straight or branched alkylene group comprising 1 to 14 carbon atoms.

14. The curable composition according to claim 1, wherein the at least one powdered-glass-based filler (B) is selected from the group consisting of fumed silica, precipitated silica, crystalline silica, fused silica, silicic anhydride, silicic acid hydrate, silica gel, silica sand, diatomaceous earth, acidic clay, white carbon, powdered quartz, powdered glass, glass flakes, glass beads, glass filaments, glass fiber, glass roving, glass mat, Shirasu balloon, and glass balloon.

15. The curable composition according to claim 5, wherein the at least one powdered-glass-based filler (B) comprises particles having sharp, irregular raised and recessed sections on the surfaces, and an average particle diameter of the particles having sharp raised and recessed sections on the surfaces is from 1 μm to 50 μm.

16. The curable composition according to claim 5, wherein the at least one powdered-glass-based-filler (B) comprises particles having needle-like or fiber-like shapes, and the major axis of the needle- or fiber-like particles is from 10 μm to 60 μm.

17. The curable composition according to claim 1, further comprising:
at least one plasticizer.

18. The curable composition according to claim 17, wherein the at least one plasticizer is a high molecular weight plasticizer having a number-average molecular weight of from 500 to 15,000.

19. The curable composition according to claim 1, further comprising:
at least one filler different from the component (B).

20. The curable composition according to claim 1, further comprising:
at least one component selected from the group consisting of an antioxidant, light stabilizer, UV absorber, and tackifier.
